(19) United States
(12) Patent Application Publication
(10) Pub. No.: US 2021/0140779 A1
(43) Pub. Date: May 13, 2021

(54) INFORMATION PROCESSING DEVICE, INFORMATION PROCESSING SYSTEM, AND COMPUTER READABLE RECORDING MEDIUM

(71) Applicant: TOYOTA JIDOSHA KABUSHIKI KAISHA, Toyota-shi (JP)

(72) Inventors: Naoki UENOYAMA, Nagoya-shi (JP); Shin SAKURADA, Toyota-shi (JP); Hikaru GOTOH, Nagoya-shi (JP)

(73) Assignee: TOYOTA JIDOSHA KABUSHIKI KAISHA, Toyota-shi (JP)

(21) Appl. No.: 17/064,909

(22) Filed: Oct. 7, 2020

(30) Foreign Application Priority Data
Nov. 7, 2019 (JP) 2019-202499

(51) Int. Cl. G01C 21/34; G01C 21/36

(52) U.S. Cl. CPC G01C 21/3492; G01C 21/3697; G01C 21/3484

(57) ABSTRACT

An information processing device includes a processor configured to: communicate with an information communication unit associated with a moving object and a traffic information server configured to output traffic information; find a traveling route for the moving object based on: the traffic information acquired from the traffic information server; and specific information associated with at least one of moving object identification information and user identification information, wherein the moving object identification information is used to identify the moving object, the user identification information being used to identify an occupant of the moving object, and the traveling route for the moving object reduces a problem of traffic in the traveling route and provides a reward to the occupant derived based on the specific information; and transmit, to the information communication unit, traveling route information including information about the found traveling route, and reward information including information about the reward.

The present application claims priority to and incorporates by reference the entire contents of Japanese Patent Application No. 2019-202499 filed in Japan on Nov. 7, 2019.

### BACKGROUND

The present disclosure relates to an information processing device, an information processing system, and a computer readable recording medium.

There is a technique for finding a new route again and presenting the new route to avoid traffic congestion that is detected on a route planned to travel during route guidance. For example, in JP 2008-139081 A, a navigation device is described that finds a route again to avoid traffic congestion that is detected based on vehicle information communication system (VICS) (registered trademark) information. In a system described in JP 2008-139081 A, when traffic congestion is detected, a route is found again in order to avoid the traffic congestion.

### SUMMARY

There is a possibility that other traffic congestion may occur even on the route derived by the route search. For this reason, there has been a demand for development of a technology that may reduce, as a whole, the occurrence of a problem of traffic flow, such as traffic congestion, on a road on which a vehicle may travel. Furthermore, there has also been a demand for a technology for finding a route that is more suitable for a vehicle occupant even when a problem of traffic flow, such as traffic congestion, occurs.

There is a need for an information processing device, an information processing system, and a computer readable recording medium that is able to reduce a traffic problem on a road on which a moving object travels, find a traveling route appropriate for an occupant of the moving object, and draw the attention of the occupant to the traveling route.

According to one aspect of the present disclosure, there is provided an information processing device including a processor including hardware, the processor being configured to: communicate with an information communication unit associated with a moving object and a traffic information server configured to output traffic information; find a traveling route for the moving object based on: the traffic information acquired from the traffic information server; and specific information associated with at least one of moving object identification information and user identification information, wherein the moving object identification information is used to identify the moving object, the user identification information being used to identify an occupant of the moving object, and the traveling route for the moving object reduces a problem of traffic in the traveling route and provides a reward to the occupant derived based on the specific information; and transmit, to the information communication unit, traveling route information including information about the found traveling route, and reward information including information about the reward.

According to another aspect of the present disclosure, there is provided an information processing system including: a first device including a first processor including hardware, the first processor being configured to communicate with an information communication unit and a traffic information server, the information communication unit being associated with a moving object, the traffic information server being configured to output traffic information; a second device including a second processor including hardware, the second processor being configured to find a traveling route for the moving object based on the traffic information acquired from the first device and specific information associated with at least one of moving object identification information and user identification information, wherein the moving object identification information is used to identify the moving object, the user identification information is used to identify an occupant of the moving object, and the traveling route reduces a problem of traffic in the traveling route and provides a reward to the occupant based on the specific information; and a third device including a third processor including hardware, the third processor being configured to transmit traveling route information found by the second device and reward information about the reward to the information communication unit.

### BRIEF DESCRIPTION OF THE DRAWINGS

FIG. 1 is a configuration diagram illustrating an information processing system according to an embodiment;

FIG. 2 is a block diagram schematically illustrating a configuration of a processing server of a route search device according to the embodiment;

FIG. 3 is a block diagram schematically illustrating a configuration of a traffic information server according to the embodiment;

FIG. 4 is a block diagram schematically illustrating a configuration of a vehicle according to the embodiment;

FIG. 5 is a block diagram schematically illustrating a configuration of a user terminal device according to the embodiment;

FIG. 6 is a sequence diagram illustrating an information processing system according to the embodiment; and

FIG. 7 is a diagram illustrating routes for description of a route search method according to the embodiment.

### DETAILED DESCRIPTION

Hereinafter, an embodiment of the present disclosure will be described with reference to the drawings. Note that, in all drawings in the following embodiment, the same or corresponding portions are denoted by the same reference numerals. Moreover, the present disclosure is not limited by the embodiment described below.

A route search system to which a route search device as an information processing device is applicable will be described. FIG. 1 illustrates the route search system according to the embodiment.

Route Search System

The route search system that is an information processing system will be described. FIG. 1 is a schematic diagram illustrating the route search system 1. As illustrated in FIG. 1, the route search system 1 includes a processing server 10, a traffic information server 20, vehicles 30 each of which includes a communication unit 32, user terminal devices 40, and reward facilities 50, which are capable of communicating with each other via a network 2. The processing server 10 includes, for example, a vehicle information database 13a, a traveling information database 13b, a user information database 13c, a preference information database 13d, a reward information database 13e, and a traffic information database 13f. The traffic information server 20 includes a traffic information database 23a. The reward facilities 50 include a plurality of facilities 50A, 50B, and 50C. The number of facilities is not limited to three.

The network 2 includes an internet network, a mobile phone network, or the like. The network 2 is, for example, a public communication network such as the Internet, and may include another communication network, such as a wide area network (WAN), telephone communication network for mobile phone or the like, or wireless communication network for WiFi (registered trademark) or the like.

Route Search Server

The processing server 10 as the information processing device used as a route search device is an information processing server of, for example, a navigation service provider that provides a navigation service to the vehicles 30, an information provider that provides predetermined information to the vehicles 30, or the like. In other words, the processing server 10 is configured to generate and manage information provided to the vehicles 30.

FIG. 2 is a block diagram schematically illustrating a configuration of the processing server 10. As illustrated in FIG. 2, the processing server 10 includes a computer that has general hardware and is communicable via the network 2. The processing server 10 includes a control unit 11, a communication unit 12, and a storage unit 13 that stores various databases. The control unit 11 includes a route search unit 14, an optimization unit 18, a reward determination unit 16, and an information collection unit 17.

The control unit 11 specifically includes a processor, such as a central processing unit (CPU), a digital signal processor (DSP), or a field-programmable gate array (FPGA), and a main storage unit, such as a random access memory (RAM) or a read only memory (ROM). The storage unit 13 includes a storage medium selected from an erasable programmable ROM (EPROM), a hard disk drive (HDD), a removable medium, and the like. Note that the removable medium is, for example, a universal serial bus (USB) memory or a disc recording medium such as a compact disc (CD), a digital versatile disc (DVD), or a Blu-ray (BD) (registered trademark) disc. The storage unit 13 is configured to store an operating system (OS), various programs, various tables, various databases, and the like. The control unit 11 loads a program stored in the storage unit 13 into a work area of the main storage unit, executes the program, and controls each component unit or the like through execution of the program. Thus, the control unit 11 may achieve the functions of the route search unit 14, a preference derivation unit 15, the reward determination unit 16, the information collection unit 17, and the optimization unit 18 to meet a predetermined purpose.

The communication unit 12 as an information acquisition unit includes, for example, a local area network (LAN) interface board or a wireless communication circuit for wireless communication. The LAN interface board or the wireless communication circuit is connected to the network 2, such as the Internet, that is a public communication network. The communication unit 12 is connected to the network 2 to communicate with the traffic information server 20, each of the vehicles 30, and each of the user terminal device 40.

The communication unit 12 is configured to receive from the traffic information server 20 various traffic information such as traffic flow information, traffic congestion information, and construction information about a road on which each vehicle 30 travels. The communication unit 12 transmits various information, such as map information and route information, to each user terminal device 40 or receives various information, such as user identification information for identifying a user and user information that is various information about the user, from the user terminal device 40.

The communication unit 12, for example, receives various information, such as vehicle identification information, vehicle information, and traveling information from each vehicle 30, or transmits an instruction signal to the vehicle 30. The vehicle identification information as moving object identification information includes unique information for individually identifying the respective vehicles 30. The vehicle information as moving object information may include various information about each vehicle 30, such as a battery charge level (SOC), a fuel level, and the status information (hereinafter, referred to as vehicle status information) and dimensional information (hereinafter, vehicle dimensional information) of the vehicle 30. The traveling information as movement information is information about traveling of each vehicle 30. The traveling information may include, but is not necessarily limited to, position information, traveling route information, travel schedule information, parking schedule information, and traveling history information as movement history information. The traveling information may further include various information about traveling of each vehicle 30, such as speed information, acceleration information, traveling distance information, and traveling time information. Note that when the vehicle 30 runs along a predetermined route that is set in advance, the traveling information may include running information. When the vehicle 30 is a rental car or the like, the vehicle information may further include information indicating the presence/absence of a user who has rented the vehicle 30, and if there is the user who has rented the vehicle 30, the vehicle information may further include user identification information indicating the user in the vehicle 30. Information included in the vehicle information and the traveling information is not necessarily limited to the above-mentioned information.

The storage unit 13 includes various databases that include, for example, relational databases (RDB). Note that manages, and each database (DB) described below is constructed by managing data stored in the storage unit 13 by a program of a database management system (DBMS) executed by the processor described above. The storage unit 13 includes the vehicle information database 13a, the traveling information database 13b, the user information database 13c, the preference information database 13d, the reward information database 13e, and the traffic information database 13f. The storage unit 13 may include only part of these databases 13a to 13f or may include another database.

The vehicle information database 13a stores vehicle information including the traveling history information and the like of a vehicle 30 that is received from each vehicle 30, in association with vehicle identification information in an updatable manner. The traveling information database 13b stores traveling information of a vehicle 30 received from each vehicle 30, in association with vehicle identification information in an updatable manner.

The vehicle identification information having been assigned to a vehicle 30 is stored in the vehicle information database 13a and traveling information database 13b, in a retrievable manner. The vehicle identification information includes various information for identifying each individual vehicle 30. When a vehicle 30 transmits predetermined information such as traveling information or vehicle information to the processing server 10 together with the vehicle identification information, the processing server 10 stores the predetermined information in the storage unit 13, in association with the vehicle identification information, in a retrievable manner. In this case, the predetermined information such as position information or vehicle information may be stored in the vehicle information database 13a or the traveling information database 13b.

The user information database 13c stores user identification information and user information about a user, in association with each other in a retrievable manner. The user information may include various information (hereinafter, referred to as user selection information) that is input or selected by a user. In a case where the vehicle 30 is a rental car, the user selection information may include, in addition to information about an item selected by each user, information about the start and end of the rental of the vehicle 30 by the user and information about basic rental fee or the like set for each user. In addition, the user selection information may include purchase history information that is history information about product purchase or facility use history information that is history information about the use of or going in and out of a facility. The user selection information may include homepage browsing history information about browsing by accessing various servers or movement history information that is a user movement history.

The user identification information having been assigned to a user is stored in the user information database 13c in a retrievable manner. The user identification information includes various information for identifying each individual user. The user identification information is, for example, a user ID for identifying each individual user and is registered in association with user-specific information, such as the name and address of the user, or position information or the like, such as a longitude and latitude representing the position or the like of the user. In other words, the user identification information includes information necessary to access the processing server 10 upon transmission and reception of information relating to the user. For example, the vehicle 30 or the user terminal device 40 transmits predetermined information, such as the user selection information, to the processing server 10, together with the user identification information. In this case, the processing server 10 stores the received information in association with the user identification information in the user information database 13c of the storage unit 13 in a retrievable manner.

The preference information database 13d stores the user identification information in association with preference information about user's preference transmitted from the user terminal device 40 or vehicle 30, in a retrievable manner. The preference information includes information about the preference of each user. The preference information may include, for each user, user driving information, such as driving behavior information or traveling history information, purchase history information including the contents of purchase of products and services, or retrieval history information upon retrieval. The preference information about these users may be derived based on information obtained from the user terminal devices 40 of the respective users, may be derived based on other information specified by the user, or may be derived by combining the information. In other words, it is possible to derive preference information for each user based on information obtained by various methods for the respective users. The processing server 10 appropriately or periodically acquires the preference information from a user terminal device 40 or a vehicle 30 and stores the preference information in the preference information database 13d in association with the user identification information.

When a user who has a user terminal device 40 gets in a vehicle 30, the user identification information and the vehicle identification information may be associated with each other. In this case, association information between the vehicle identification information and the user identification information is stored in a necessary database selected from the vehicle information database 13a, the traveling information database 13b, the user information database 13c, and the preference information database 13d.

The reward information database 13e stores reward information in association with the position information in a retrievable manner. The reward information is information about a reward that may be provided to the user. Here, the reward represents a value, situation, event, or the like that may provide a user who is an occupant of a vehicle 30 an incentive to drive on a predetermined road. Specifically, the reward may be, for example, a discount coupon that may be used at a store or the like near a road along which the vehicle 30 may travel or information about reward points, a reward, or the like that may be earned at a store or the like. Note that the reward is not limited to money or goods but may adopt various things that provides the user an incentive to drive along a predetermined road and attracts the attention of the user.

The traffic information database 13f stores various traffic information, such as traffic flow information, traffic congestion information, accident information, and construction information on a road on which a vehicle 30 travels in association with position information in a retrievable manner. The traffic flow information includes information about the traffic flow of the vehicles 30 traveling on a road that is obtained by a conventionally known method. Note that the traffic flow may be expressed as a relationship between traffic flow rate and traffic density. The traffic flow rate may be defined by the number of vehicles 30 passing through an observation point on a road per unit time, and the traffic density may be defined by the number of vehicles 30 per unit length. Note that the traffic flow information may be information other than the information about the relationship between traffic flow rate and traffic density. The traffic congestion information includes information about traffic congestion on a road caused by a plurality of vehicles 30. The accident information includes information about various accidents or traveling obstacles on the road. The construction information includes information about various constructions, such as a schedule and range of road construction and traffic restriction. The processing server 10 acquires the traffic information from the traffic information server 20 appropriately or periodically and stores the traffic information in the traffic information database 13f in association with the position information in a retrievable manner.

The route search unit 14 generates and acquires traveling route information based on information about a departure place and information about a destination that are input or selected by a user. The route search unit 14 generates and acquires traveling route information based on map information by information processing according to a predetermined program. The route search unit 14 may supply the generated traveling route information to the optimization unit 18. The route search unit 14 stores the generated traveling route information in the traveling information database 13b in association with user identification information and vehicle identification information. The route search unit 14 may include a learned model generated by machine learning. Here, the learned model may be generated by machine learning with an input/output dataset including predetermined input parameters and output parameters as teaching data. The learned model may be a learned model that is generated with an input/output dataset as the teaching data, and the input/output dataset uses a departure place and destination as the input parameters and uses predetermined traveling route information as an output parameter.

The preference derivation unit 15 derives user preference information based on at least one of vehicle information or traveling information acquired from a vehicle 30 and user information acquired from the user terminal device 40. The preference derivation unit 15 derives user preference information based on user selection information input from a user terminal device 40 by a user or traveling history information or the like of driving of a vehicle 30 by the user. The preference information is information about a user's preference, that is, information about a user's favorite item, behavior, scene, or the like. The preference derivation unit 15 stores the derived preference information in the preference information database 13d in association with user identification information. Note that the preference information may be stored in the preference information database in association with vehicle identification information.

The reward determination unit 16 determines, based on user preference information stored in the preference information database 13d, whether there is reward information corresponding to the user preference information under a predetermined condition. In other words, the reward determination unit 16 determines whether the reward information database 13e may be searched to retrieve the reward information corresponding to the user preference information, under a predetermined condition. Note that the reward determination unit 16 may include a learned model generated by machine learning. The result of the determination of the presence or absence of the reward information determined by the reward determination unit 16 is supplied as reward determining information to the optimization unit 18.

The information collection unit 17 collects, from various servers or the like, information that may be collected via the network 2. The information collection unit 17 specifically acquires traffic information from the traffic information server 20, acquires vehicle information or traveling information from each vehicle 30, acquires user information from each user terminal device 40, and acquires reward information from each of the reward facilities 50 (50A, 50B, and 50C). The information collection unit 17 stores the acquired vehicle information or traveling information in the vehicle information database 13a and traveling information database 13b, in association with vehicle identification information in a retrievable manner. The information collection unit 17 stores the acquired user information in the user information database 13c in association with user identification information. The information collection unit 17 stores the acquired reward information in the reward information database 13e in association with position information. The information collection unit 17 stores the acquired traffic information in the traffic information database 13f.

The optimization unit 18 selects traveling route information that may reduce traffic problems based on traffic information stored in the traffic information database 13f. The optimization unit 18 specifically selects a traveling route for each vehicle 30 to reduce the frequency of traffic congestion on a predetermined road. Note that the reduction of traffic problems includes not only reduction in the frequency of traffic congestion but also reduction in the frequency of automobile accidents. The optimization unit 18 supplies the selected traveling route information to the route search unit 14. The optimization unit 18 may include a learned model that is configured to select an appropriate traveling route for each vehicle 30. The learned model may be generated by machine learning with an input/output dataset including predetermined input parameters and output parameters as teaching data. For each of the input parameters, necessary information is selected from date and time information including date, day of the week, and time, climate information including weather and temperature, event information of surrounding facilities, facility information about facilities such as traffic lights or railroad crossings along a road, information about the number of vehicles 30, and average speed information of the vehicles 30. Each of the output parameters may be a traffic flow rate and traffic density in a traffic flow on a road and a relationship therebetween or a result of simulation of traffic congestion. Note that as a method of generating an artificial intelligence (AI) model, deep reinforcement learning such as DQN may be adopted.

Traffic Information Server

The traffic information server 20 illustrated in FIG. 1 collects traffic information on a road and acquires information about traffic or the like on the road. FIG. 3 is a block diagram schematically illustrating a configuration of the traffic information server 20. As illustrated in FIG. 3, the traffic information server 20 includes a control unit 21, a communication unit 22, a storage unit 23, and a traffic information collection unit 24. The control unit 21, the communication unit 22, and the storage unit 23 are physically similar to the control unit 11, the communication unit 12, and the storage unit 13 which are described above, respectively. The storage unit 23 stores a traffic information database 23a.

The communication unit 22 is connected to the network 2 and communicates with a beacon that acquires traffic information or the processing server 10. The communication unit 22 transmits the traffic information to the processing server 10. Information transmitted by the communication unit 22 is not limited to such information.

The traffic information collection unit 24 collects traffic information from, for example, a beacon or the like installed on a road or the like via the communication unit 22. The traffic information collected by the traffic information collection unit 24 is stored in the traffic information database 23a of the storage unit 23 in a retrievable manner. The traffic information collection unit 24 may further include a storage unit. Furthermore, the traffic information collection unit 24 may be configured separately from the control unit 21, the communication unit 22, and the storage unit 23.

Vehicle

A vehicle 30 as a moving object includes a vehicle that travels by the driving of a driver or an autonomous vehicle that is configured to travel autonomously according to a given travel command. FIG. 4 is a block diagram schematically illustrating a configuration of the vehicle 30. As illustrated in FIG. 4, the vehicle 30 includes a control unit 31, a communication unit 32, a storage unit 33, a positioning unit 34, an input/output unit 35, a key unit 36, and a drive unit 37.

The control unit 31, the communication unit 32, and the storage unit 33 are physically similar to the control unit 11, the communication unit 12, and the storage unit 13 which are described above, respectively. The control unit 31 integrally controls operations of various component elements mounted to the vehicle 30. The communication unit 32 as a communication terminal of the vehicle 30 includes, for example, a data communication module (DCM) that communicates with the processing server 10 by wireless communication via the network 2.

The storage unit 33 includes a vehicle information database 33a, a traveling information database 33b, and a user information database 33c. The vehicle information database 33a stores various information including an SOC, a fuel level, vehicle dimensional information, and the like, in an updatable manner. The traveling information database 33b stores various information including traveling information measured and generated by the control unit 31 based on various information obtained from the positioning unit 34 and the drive unit 37, in an updatable manner. The user information database 33c stores user information about a user, such as an occupant or a driver, acquired from a user terminal device 40 of the occupant who is in the vehicle 30 or generated based on traveling information or the like of the vehicle 30. Note that various methods may be adopted as a method of acquiring the user information. The vehicle information, the traveling information, and the user information described above at least partially form specific information unique to each user or each vehicle 30.

The positioning unit 34, for example, receives a radio wave from a global positioning system (GPS) satellite and detects the position of the vehicle 30. The position and route of a vehicle 30 detected by the positioning unit 34 as a position information acquisition unit for the vehicles 30 are stored, as position information and traveling route information of traveling information, in the vehicle information database 33a in a retrievable manner. Note that, as a method of detecting the position of a vehicle 30, a method obtained by combining light detection and ranging, laser imaging detection and ranging (LiDAR) with a three-dimensional digital map may be employed.

The input/output unit 35 includes a touch panel display, a speaker-microphone, or the like. The input/output unit 35 as an output unit is configured to display letters, figures, and the like on a screen of the touch panel display or output voice from a speaker-microphone, according to control by the control unit 31 to enable notification of predetermined information to the outside. Furthermore, the input/output unit 35 as an input unit is configured so that the user or the like operates the touch panel display or speaks to the speaker-microphone to enable input of predetermined information to the control unit 31.

Note that the vehicle 30 according to the present embodiment includes the positioning unit 34 and the input/output unit 35 as separate functions, but the vehicle 30 may include, instead of the positioning unit 34 and the input/output unit 35, an in-vehicle navigation system with a communication function that also has the functions of the positioning unit 34 and the input/output unit 35.

The key unit 36 is configured so that authentication based on, for example, BLE authentication information is performed between the key unit 36 and the user terminal device 40 to enable locking and unlocking of the vehicle 30. The drive unit 37 is a drive unit that performs driving necessary for traveling of the vehicle 30. Specifically, the vehicle 30 includes an engine as a drive source, and the engine is configured to burn fuel to drive a motor or the like and generate power. The generated power is stored in a rechargeable battery. Furthermore, the vehicle 30 further includes a drive transmission mechanism, drive wheels for traveling, and the like, and the drive transmission mechanism transmits a driving force of the engine.

User Terminal Device

A user terminal device 40 as a terminal that constitutes an information communication unit is operated by a user. The user terminal device 40 transmits, to the processing server 10, various data via a communication application and various information such as user identification information and user information including user selection information via a voice telephone call. The user terminal device 40 is configured to receive various information such as traveling route information and, if necessary, electronic key data from the processing server 10. FIG. 5 is a block diagram schematically illustrating a configuration of the user terminal device 40 illustrated in FIG. 1.

As illustrated in FIG. 5, the user terminal device 40 includes a control unit 41, an input unit 42, a display unit 43, a communication unit 44, a storage unit 45, and a positioning unit 46 that are communicably connected to each other. The control unit 41, the communication unit 44, and the storage unit 45 are physically similar to the control unit 11, the communication unit 12, and the storage unit 13 which are described above, respectively. The positioning unit 46 is physically similar to the positioning unit 34 described above.

The control unit 41 is configured to execute various programs stored in the storage unit 45 and store various tables, various databases, and the like in the storage unit 45. The control unit 41 loads OS and a service application 45a that are stored in the storage unit 45 into a work area of a main storage unit, executes the OS, and integrally controls the operations of the input unit 42, display unit 43, communication unit 44, storage unit 45, and positioning unit 46. In the present embodiment, a locking/unlocking request program 45b is incorporated into the service application 45a, for example, in the form of a software development kit (SDK).

The locking/unlocking request program 45b is executed by the service application 45a of the user terminal device 40, authentication is performed between the user terminal device 40 and the key unit 36 based on, for example, BLE authentication information, thus, locking and unlocking a vehicle 30. This allows the vehicle 30 to acquire the user information about the user in the vehicle 30. In other words, when the user of the user terminal device 40 gets in a vehicle 30, the user identification information may be associated with vehicle identification information. The same applies to a case in which each of a plurality of occupants carries a user terminal device 40. The user information acquired by the vehicle 30 is stored in the user information database 45c by the control unit 41. Note that for the locking/unlocking of the vehicle 30 through communication between the user terminal device 40 and the key unit 36, various conventionally known methods may be employed.

The input unit 42 includes, for example, a keyboard, a touch panel keyboard that is incorporated in the display unit 43 to detect a touch operation on a display panel, a voice input device that enables to make an external phone call, or the like. Here, the external phone call includes not only a telephone call with another user terminal device 40 but also, for example, a telephone call with an operator who operates the processing server 10 or a telephone call with an artificial intelligence system.

The display unit 43 includes, for example, an organic EL panel or a liquid crystal display panel and displays letters, figures, and the like on a display panel to show information. The input unit 42 and the display unit 43 may be configured similarly to the input/output unit 35 described above.

The communication unit 44 exchanges various information, such as the user identification information, the user selection information, and voice data, with an external server such as the processing server 10 or a vehicle 30 via the network 2. The storage unit 45 includes the user information database 45c to store the user information in association with the user identification information. The positioning unit 46 as a position information acquisition unit of the user terminal device 40 is configured to detect the position of the user terminal device 40 by communicating with, for example, a GPS satellite. The detected position information may be transmitted as user position information to the processing server 10 or the vehicle 30 via the network 2, in association with the user identification information.

The user terminal device 40 as described above is configured to, specifically, use various devices that may be carried by the user, such as a mobile phone, including a smartphone or the like, or an information terminal of a tablet type. Furthermore, the user terminal device 40 may include an in-vehicle terminal fixed to a vehicle 30, a portable terminal that may be carried by a user, or an operation terminal that is configured to be attached to and detached from a predetermined portion of a vehicle 30.

Route Search Method

Next, a route search method performed by the processing server 10 of the route search system 1 configured as described above will be described. In the following description, transmission and reception of information are performed via the network 2, but repetitive description thereof will be omitted. Furthermore, when information is transmitted from each vehicle 30 or each user terminal device 40, vehicle identification information for identifying the vehicle 30 or user identification information for identifying the user terminal device 40 is also transmitted in association with the information transmitted, but repetitive description thereof will also be omitted. Still furthermore, in the following description, a search process for traveling route information for one vehicle 30 will be described, but the processing server 10 also performs a similar search process for many other vehicles 30. Therefore, a traffic flow on a road may be optimized as a whole.

In step ST1, a vehicle 30 periodically transmits vehicle information and traveling information to the processing server 10. The processing server 10 acquires planned route information that is information about a route on which the vehicle 30 is planned to travel after a current time, based on acquired traveling information. In step ST2, a user terminal device 40 transmits user information to the processing server 10. Here, the user terminal device 40 is a terminal carried by a user (hereinafter, referred to as an occupant) who is in the vehicle 30. When there are a plurality of occupants and each occupant carries a user terminal device 40, each user terminal device 40 may transmit user information to the processing server 10. The control unit 11 of the processing server 10 may acquire the planned route information about a road on which the vehicle 30 is planned to travel after a current time, based on the user selection information included in the user information. In step ST3, the traffic information server 20 periodically transmits traffic information collected to the processing server 10. Note that the traffic information may include traffic congestion information. In step ST4, each of the reward facilities 50 timely transmits reward information to the processing server 10.

Steps ST1, ST2, ST3, and ST4 are performed periodically or at appropriate timing in the route search method and may be performed reversely or parallelly. The processing server 10 that has acquired information stores the acquired information in the databases 13a to 13f corresponding to the information.

In step ST5, the route search unit 14 in the control unit 11 of the processing server 10 generates traveling route information including information about at least one route on which the vehicle 30 may travel, based on planned route information corresponding to time after a current time. Specifically, the route search unit 14 finds a plurality of routes based on position information included in the traveling information and destination information included in the planned route information and generates traveling route information including information about a plurality of routes. The route search unit 14 supplies the generated traveling route information to the optimization unit 18. The optimization unit 18 simulates a traveling route for the vehicle 30 based on the traffic information acquired from the traffic information server 20. At this time, it is determined which traveling route the vehicle 30 should travel along among the traveling routes that the route search unit 14 has found for the vehicle 30 to reduce the problem of traffic flow, for example, the problem of traffic congestion or the like. Note that the other traveling routes for the vehicle 30 may also be simulated.

Here, FIG. 7 is a diagram illustrating an example of traveling routes the route search unit 14 has found. Note that a description made with reference to FIG. 7 is merely an example, and the present disclosure is not limited to the contents illustrated in FIG. 7. As illustrated in FIG. 7, for example, it is assumed that three routes of a route A, a route B, and a route C are found, after the vehicle 30 starts from a current position as the starting point and before the vehicle 30 reaches a destination that is included in the planned route information. In the example illustrated in FIG. 7, the traveling route information includes information about the three routes. The optimization unit 18 simulates the traveling of the vehicle 30 along the route A, route B, and route C, determining the situations of traffic flow. It is assumed that the optimization unit 18 determines that the route A has the lowest possibility of reducing a problem of traffic flow, for example, the lowest possibility of reducing a traffic congestion probability, the route B has a lower possibility thereof, and the route C has the highest possibility thereof. In this case, the optimization unit 18 generates traveling route information including information about the route C. Note that the route C may be selected firstly and the route B may be selected secondly to generate traveling route information including information about two routes of the route C and the route B.

Then, the optimization unit 18 acquires preference information about an occupant of the vehicle 30 from the preference information database 13d based on user information about the occupant of the vehicle 30. The optimization unit 18 outputs the acquired preference information to the reward determination unit 16. When no occupant preference information about the occupant of the vehicle 30 is stored in the preference information database 13d, the preference derivation unit 15 derives the preference information based on the user information about the occupant and stores the preference information in the preference information database 13d. In this case, the preference derivation unit 15 may output the preference information to the reward determination unit 16.

Returning to FIG. 6, in step ST6, and the reward determination unit 16 searches the reward information database 13e for reward information corresponding to the preference information, based on the occupant preference information input from the optimization unit 18. The optimization unit 18 searches the reward information database 13e for reward information corresponding to the acquired preference information. Subsequently, in step ST7, the reward determination unit 16 determines whether reward information corresponding to the acquired preference information is stored in the reward information database 13e. In other words, the reward determination unit 16 is configured to determine that the reward information is stored, when reward information corresponding to the acquired preference information is retrieved, and determine that no reward information is stored, when no reward information corresponding to the acquired preference information is retrieved.

When the reward determination unit 16 determines that no reward information is stored (step ST7: No), the process of searching for a route that is performed by the processing server 10 ends. When the reward determination unit 16 determines that the reward information is stored (step ST7: Yes), the reward information is output to the optimization unit 18, and the process proceeds to step ST8. In step ST8, the optimization unit 18 transmits the generated traveling route information and the acquired reward information to the vehicle 30. In step ST9, in the vehicle 30 that has acquired the traveling route information and the reward information, the control unit 31 outputs the acquired traveling route information, that is, navigation information and the reward information to the input/output unit 35.

Furthermore, in step ST8, the optimization unit 18 may transmit the generated traveling route information and the acquired reward information to the user terminal device 40. When there are a plurality of occupants, the traveling route information and the reward information may be transmitted to at least one user terminal device 40 of any of the occupants or may be transmitted to all the user terminal devices 40. In step ST 10, the control unit 41 of the user terminal device 40 that has acquired the traveling route information and the reward information outputs the acquired traveling route information, that is, the navigation information and the reward information to the display unit 43.

Here, the reward information corresponding to the occupant preference information is specifically the following information. Specifically, for example, as illustrated in FIG. 7, in the route B, there are stores at points P₁ and P₃, and in the stores, predetermined products may be purchased and predetermined services may be enjoyed. When the occupant preference information includes information about the history of purchasing a predetermined product or receiving a predetermined service, the corresponding reward information indicates that driving along the route B along which these stores may be available, using the stores at the points P₁ and P₃, and, for example, acquiring discount coupons or the like. When the occupant preference information includes information that user likes to see a beautiful scene, derived from user selection information or the like, the corresponding reward information indicates, for example, that the vehicle 30 travels along the route B to see a beautiful scene at a point P₅.

As illustrated in FIG. 7, on the route A, for example, there is a store at a point P₂ that matches the taste of the occupant. For example, when the occupant preference information includes occupant taste information, the corresponding reward information indicates that there is a store matching the taste of the occupant at the point P₂. Furthermore, for example, when the point P₅ is a mountain area and a point P₄ is a coast and the preference information includes information indicating that the user prefers to enjoy the view of the sea, the corresponding reward information indicates, as information that gives the occupant an incentive to drive the route A, that the point P₄ is the sea and driving along the route A provides the view of the sea.

For example, the occupant preference information may include skill information indicating a driving skill of a driver. As illustrated in FIG. 7, the route A and the route B have traveling roads with a small curvature radius, such as traveling roads S₂ and S₃. On the other hand, in the route C has a few traveling roads with a small curvature radius, such as the traveling roads S₂ and S₃ and has many traveling roads with a large curvature radius, such as a traveling road S₁. When the optimization unit 18 determines that the user driving the vehicle 30 has a low driving skill, based on the skill information, the optimization unit 18 may select the route C having a few traveling roads with a small curvature radius, as a route having a high possibility of reducing the problem of traffic flow. This is because, in general, driving along a traveling road with a large curvature radius enables more safe traveling of the vehicle 30. In this case, the reward determination unit 16 may retrieve information about a store or the like at a point P₆ on the route C as the reward information, from the reward information database 13e based on other preference information about the driver of the vehicle 30.

An occupant notified of the traveling route information and the reward information as described above from at least one of the input/output unit 35 of the vehicle 30 and the display unit 43 of the user terminal device 40 may change a route to a route that may reduce the problem of traffic flow. Therefore, the traffic flow of the whole or part of a predetermined road may be optimized in a traveling route to the destination.

According to the embodiment, reducing the occurrence of a problem of traffic flow while proposing a route along which an occupant may receive a reward makes it possible to find an appropriate route for a vehicle occupant even if a problem of traffic flow such as traffic congestion. Furthermore, it is possible to more appropriately select a type of reward that may be provided to the occupant of the vehicle 30, based on information obtained from the user terminal device 40 of the occupant or information obtained from the vehicle 30. Use of the user terminal device 40 of the occupant of the vehicle 30 makes it possible to selectively notify of reward information that may be provided for the occupant, based on user information about all the occupants or a specific occupant in a moving object, such as a vehicle 30.

Information Processing System

Furthermore, according to another embodiment, the functions of the route search unit 14, the preference derivation unit 15, the reward determination unit 16, the information collection unit 17, and the optimization unit 18 may be divided so that a plurality of devices that is communicable with each other via the network 2 is caused to perform the functions thereof. For example, a first device including a first processor may be caused to perform at least part of the function of the information collection unit 17. A second device including a second processor may be caused to perform at least part of the functions of the route search unit 14, the reward determination unit 16, and the optimization unit 18. A third device including a third processor may be caused to perform at least part of the function of the optimization unit 18. A fourth device including a fourth processor may be caused to perform at least part of the function of the preference derivation unit 15. A fifth device including a fifth processor may be caused to perform at least part of the function of the reward determination unit 16 that is performed in cooperation with the reward information database 13e of the storage unit 13 serving as a memory. Here, each of the first to fourth devices may be configured to transmit and receive information to and from each other via the network 2 or the like. In this case, at least one of the first to fourth devices, for example, the third device may be mounted to a vehicle 30.

Recording Medium

In an embodiment described above, a program configured to perform a method of processing information by the processing server 10 may be recorded on a recording medium that is readable by a computer or other machines or devices (hereinafter, referred to as a computer or the like). The computer or the like is caused to read and execute the program recorded on the recording medium, and thereby the computer functions as the processing server 10 as the information processing device. Here, the recording medium readable by a computer or the like represents a non-transitory recording medium that is configured to electrically, magnetically, optically, mechanically, or chemically store information, such as data or programs, so as to be read by the computer or the like. Of such recording media, recording media removable from computers or the like include, for example, flexible disks, magneto-optical disks, CD-ROMs, CD-R/Ws, DVDs, BDs, DATs, magnetic tapes, and memory cards such as flash memories. Furthermore, recording media fixed to computers or the like include hard disks, ROMs, and the like. Furthermore, an SSD may be used as a recording medium removable from a computer or the like and also as a recording medium fixed to a computer or the like.

### Other Embodiments

Furthermore, in a vehicle according to an embodiment, “unit” described above may be read as “circuit” or the like. For example, the communication unit may be read as a communication circuit.

Furthermore, a program executed by the information processing device according to an embodiment has installable or executable file data and is provided by being recorded on a computer-readable recording medium, such as a CD-ROM, flexible disk (FD), CD-R, digital versatile disk (DVD), USB medium, or flash memory. Still furthermore, a program executed by the information processing device according to an embodiment may be configured to be stored on a computer connected to a network such as the Internet and provided by being downloaded via the network.

Note that, in the description of the flowchart in the present specification, although the expressions, such as “firstly”, “then”, “subsequently”, are used to clarify the order of processing between steps, the order of processing necessary to implement the present embodiment is not defined uniquely by these expressions. In other words, the order of processing in the flowcharts described in the present specification may be changed as long as consistency is maintained.

Furthermore, in an embodiment described above, reducing the problem of traffic flow may include reducing or optimizing a traveling time to reach the destination. In this case, the control unit 11 of the processing server 10 may simulate the traveling time, based on driving skill information indicating the driving skill of a driver of a vehicle 30, traveling history information in the past, or the like to select route having a shortest or optimum traveling time.

Furthermore, in an embodiment described above, step ST8 may be divided into two steps of transmitting the traveling route information and transmitting the reward information. In this case, in step ST7, when it is determined that no reward information is stored, the process may proceed to a step of transmitting the traveling route information without transmitting the reward information, thus, transmitting the traveling route information to the vehicle 30 or the user terminal device 40.

According to the present disclosure, it is possible to reduce a traffic problem on a road on which a moving object travels, find a traveling route appropriate for an occupant of the moving object, and draw the attention of the occupant to the traveling route.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising
a processor comprising hardware, the processor being configured to:
communicate with an information communication unit associated with a moving object and a traffic information server configured to output traffic information;
find a traveling route for the moving object based on: the traffic information acquired from the traffic information server; and specific information associated with at least one of moving object identification information and user identification information, wherein the moving object identification information is used to identify the moving object, the user identification information being used to identify an occupant of the moving object, and the traveling route for the moving object reduces a problem of traffic in the traveling route and provides a reward to the occupant derived based on the specific information; and
transmit, to the information communication unit, traveling route information including information about the found traveling route, and reward information including information about the reward.

2. The information processing device according to claim 1, wherein the processor is configured to derive preference information about a preference of the occupant based on the specific information.

3. The information processing device according to claim 2, further comprising a memory configured to store the reward information, wherein
the processor is configured to search the memory for reward information corresponding to the preference information.

4. The information processing device according to claim 1, wherein the processor is configured to acquire, from the traffic information server, information about traffic flow of a plurality of moving objects added to the traffic information.

5. The information processing device according to claim 1, wherein the specific information is at least one of moving object information about the moving object, movement information about movement of the moving object, and user information about the occupant.

6. The information processing device according to claim 1, wherein the specific information includes at least one selected from purchase history information, facility use history information, homepage browsing history information, and movement history information that are stored in the information communication unit, and traveling history information, position information, and vehicle information that are stored in a memory of the moving object.

7. The information processing device according to claim 1, wherein the specific information includes preference information about a preference of the occupant.

8. The information processing device according to claim 1, wherein the information communication unit is a user terminal device belonging to the occupant.

9. The information processing device according to claim 1, wherein the problem of traffic includes traffic congestion.

10. The information processing device according to claim 1, wherein the moving object identification information and the user identification information are associated with each other.

11. An information processing system comprising:
a first device comprising a first processor comprising hardware, the first processor being configured to communicate with an information communication unit and a traffic information server, the information communication unit being associated with a moving object, the traffic information server being configured to output traffic information;
a second device comprising a second processor comprising hardware, the second processor being configured to find a traveling route for the moving object based on the traffic information acquired from the first device and specific information associated with at least one of moving object identification information and user identification information, wherein the moving object identification information is used to identify the moving object, the user identification information is used to identify an occupant of the moving object, and the traveling route reduces a problem of traffic in the traveling route and provides a reward to the occupant based on the specific information; and
a third device comprising a third processor comprising hardware, the third processor being configured to transmit traveling route information found by the second device and reward information about the reward to the information communication unit.

12. The information processing system according to claim 11, further comprising a fourth device comprising a fourth processor comprising hardware, the fourth processor being configured to derive preference information about a preference of the occupant based on the specific information.

13. The information processing system according to claim 12, further comprising a fifth device comprising:
a memory configured to store the reward information; and
a fifth processor comprising hardware, the fifth processor being configured to search the memory for the reward information corresponding to the preference information.

14. The information processing system according to claim 11, wherein the first processor is configured to acquire, from the traffic information server, information about traffic flow of a plurality of moving objects added to the traffic information.

15. The information processing system according to claim 11, wherein the specific information is at least one of moving object information about the moving object, movement information about movement of the moving object, and user information about the occupant.

16. The information processing system according to claim 11, wherein the specific information includes at least one selected from purchase history information, facility use history information, homepage browsing history information, and movement history information that are stored in the information communication unit, and traveling history information, position information, and vehicle information that are stored in a memory of the moving object.

17. The information processing system according to claim 11, wherein the specific information includes preference information about a preference of the occupant.

18. The information processing system according to claim 11, wherein the problem of traffic includes traffic congestion.

19. The information processing system according to claim 11, wherein the moving object identification information and the user identification information are associated with each other.

20. A non-transitory computer-readable recording medium on which an executable program is recorded, the program instructing a processor to execute:
finding a traveling route for a moving object based on: traffic information acquired from a traffic information server configured to output traffic information; and specific information associated with at least one of: moving object identification information acquired from the moving object and used to identify the moving object; and user identification information acquired from an information communication unit associated with the moving object and used to identify an occupant of the moving object, wherein the traveling route reduces a problem of traffic in the traveling route and provides a reward to the occupant derived based on the specific information; and
transmitting information about the found traveling route and reward information about the reward to the information communication unit.
